(19) United States
(12) Patent Application Publication
(10) Pub. No.: US 2015/0222793 A1
(43) Pub. Date: Aug. 6, 2015

(54) CAMERA MODULE

(71) Applicant: SAMSUNG ELECTRO-MECHANICS CO., LTD., Suwon-Si (KR)

(72) Inventors: Hwan Jun Kang, Suwon-Si (KR); Dae Wook Kim, Suwon-Si (KR)

(73) Assignee: SAMSUNG ELECTRO-MECHANICS CO., LTD., Suwon-Si (KR)

(21) Appl. No.: 14/262,065

(22) Filed: Apr. 25, 2014

(30) Foreign Application Priority Data
Feb. 6, 2014 (KR) 10-2014-0013443

(51) Int. Cl. H04N 5/225

(52) U.S. Cl. CPC H04N 5/2254

(57) ABSTRACT

There is provided a camera module including: an actuator housing accommodating a lens barrel therein; a sensor housing disposed below the actuator housing; a cushion pad disposed between the actuator housing and the sensor housing; a board coupled to a lower portion of the sensor housing and having an image sensor mounted thereon; and a plurality of support wires, one ends thereof being fixed to the actuator housing and the other end fixed to the board.

### CROSS-REFERENCE TO RELATED APPLICATION

This application claims the benefit of Korean Patent Application No. 10-2014-0013443 filed on Feb. 6, 2014, with the Korean Intellectual Property Office, the disclosure of which is incorporated herein by reference.

### BACKGROUND

The present disclosure relates to a camera module.

Recently, a portable electronic device such as a mobile phone, a personal digital assistant (PDA), a portable personal computer (PC), or the like, has generally been implemented with the ability to perform the transmission of video data as well as the transmission of text or audio data.

In accordance with this trend, camera modules have recently been standardly installed in portable electronic devices in order to enable the transmission of the video data, allowing for video chatting, and the like.

Generally, such a camera module includes a lens barrel having lenses disposed therein, a housing accommodating the lens barrel therein, and an image sensor converting an image of a subject into electrical signals.

In addition, a fixed-focus type camera module imaging a subject by a fixed focus may be adopted as the camera module. However, recently, in accordance with development of optical technology, a camera module including an actuator so that auto-focusing may be performed has been adopted.

In order to perform auto-focusing, the lens barrel is moved in an optical axis direction. In this case, the lens barrel should be moved in parallel with an optical axis, and the optical axis should be disposed perpendicularly to an image forming surface of the image sensor.

However, the optical axis of the lens may not be aligned perpendicularly to the image forming surface of the image sensor with prefect precision, due to an assembly tolerance, or the like, in a process of assembling a camera module.

### SUMMARY

An aspect of the present disclosure may provide a camera module capable of easily securing perpendicularity of an optical axis of a lens with respect to an image forming surface of an image sensor.

An aspect of the present disclosure may also provide a camera module capable of preventing perpendicularity of an optical axis of a lens with respect to an image forming surface of an image sensor from being distorted in an adhesive hardening process.

An aspect of the present disclosure may also provide a camera module having improved bonding strength through fixing support wires to an actuator housing through soldering.

An aspect of the present disclosure may also provide a camera module capable being easily repaired by removing support wires when defects due to foreign objects and performance defects occur.

An aspect of the present disclosure may also provide a camera module capable of preventing defects due to foreign objects by disposing a cushion pad between an actuator housing and a sensor housing.

According to an aspect of the present disclosure, a camera module may include: an actuator housing accommodating a lens barrel therein; a sensor housing disposed below the actuator housing; a cushion pad disposed between the actuator housing and the sensor housing; a board coupled to a lower portion of the sensor housing and having an image sensor mounted thereon; and a plurality of support wires, one ends thereof being fixed to the actuator housing and the other end fixed to the board.

The cushion pad may be attached to an upper edge of the sensor housing.

An upper portion of the cushion pad may contact a lower portion of the actuator housing, and a lower portion thereof may contact an upper portion of the sensor housing.

The cushion pad may be any one of an elastic plate, a wave spring, and a silicon having elasticity.

The actuator housing, the cushion pad, and the sensor housing may have avoidance grooves formed therein, respectively, so that the support wires pass therethrough.

The actuator housing may have fixing protrusions protruding from a lower portion thereof, and the sensor housing may have fixing grooves formed in an upper portion thereof so as to correspond to the fixing protrusions.

The fixing groove may have a size larger than that of the fixing protrusion.

The cushion pad may have guide grooves formed therein so as to correspond to the fixing grooves.

The actuator housing may have pressing grooves formed in an upper surface thereof.

The sensor housing may have a step part formed on an upper surface thereof, wherein the step part has an infrared filter seated thereon.

One end and the other end of the support wire may be soldered to the actuator housing and the board, respectively.

According to another aspect of the present disclosure, a camera module may include: an actuator housing accommodating a lens barrel therein; a sensor housing disposed below the actuator housing and having an infrared filter attached to an upper surface thereof; a cushion pad disposed between the actuator housing and the sensor housing and pressing at least one side of the actuator housing to adjust horizontality of the actuator housing to the sensor housing; a board coupled to a lower portion of the sensor housing and having an image sensor mounted thereon; and a plurality of support wires each having one end fixed to the actuator housing and the other end fixed to the board.

The actuator housing may have fixing protrusions protruding from a lower portion thereof, and the sensor housing may have fixing grooves formed in an upper portion thereof so as to correspond to the fixing protrusions.

The fixing groove may have a size larger than that of the fixing protrusion.

A position of the actuator housing may be fixed by the support wires.

One end and the other end of the support wire may be soldered to the actuator housing and the board, respectively.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exploded perspective view of a camera module according to an exemplary embodiment of the present disclosure;

FIG. 2 is an assembled perspective view of the camera module according to an exemplary embodiment of the present disclosure;

FIG. 3 is a partial assembled perspective view of the camera module according to an exemplary embodiment of the present disclosure;

FIG. 4 is a plan view showing a form before a case is coupled to the camera module according to an exemplary embodiment of the present disclosure;

FIG. 5 is a schematic cross-sectional view showing the form before the case is coupled to the camera module according to an exemplary embodiment of the present disclosure;

FIGS. 6A through 6C are partially assembled perspective views showing examples of fixing a support wire in the camera module according to an exemplary embodiment of the present disclosure;

FIG. 7 is a perspective view of a sensor housing of the camera module according to an exemplary embodiment of the present disclosure;

FIG. 8 is an assembled perspective view of the sensor housing and a cushion pad of the camera module according to an exemplary embodiment of the present disclosure;

FIG. 9 is a plan view and a side view of the sensor housing and the cushion pad of the camera module according to an exemplary embodiment of the present disclosure; and

FIG. 10 is a bottom perspective view showing a form in which an actuator housing and the cushion pad of the camera module according to an exemplary embodiment of the present disclosure are coupled to each other.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

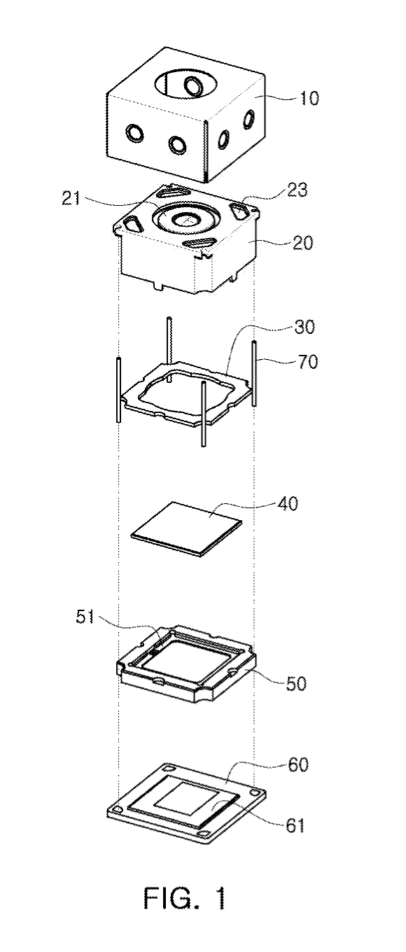

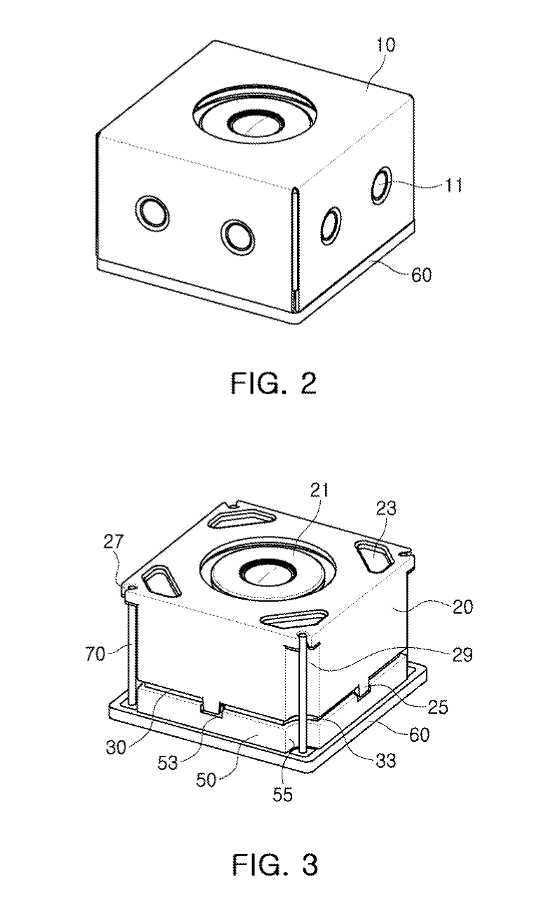

FIG. 1 is an exploded perspective view of a camera module according to an exemplary embodiment of the present disclosure; and FIG. 2 is an assembled perspective view of the camera module according to an exemplary embodiment of the present disclosure.

Referring to FIGS. 1 and 2, the camera module according to an exemplary embodiment of the present disclosure may include a lens barrel 21, an actuator housing 20, a cushion pad 30, a sensor housing 50, a board 60, support wires 70, and a case 10.

Terms with respect to directions will be first defined. An optical axis direction refers to a vertical direction based on the lens barrel 21, and a horizontal direction refers to a direction perpendicular to the optical axis direction.

The lens barrel 21 may have a hollow cylindrical shape so that at least one lens imaging a subject may be accommodated therein, and the lens may be disposed in the lens barrel 21 along an optical axis.

The lens barrel 21 maybe coupled to the actuator housing 20. In detail, the lens barrel 21 may be disposed in the actuator housing 20.

Here, the lens barrel 21 may be moved in the optical axis direction within the actuator housing 20 for auto-focusing.

In order to move the lens barrel 21 in the optical axis direction, an actuator (not shown) including a magnet (not shown) and a coil (not shown) disposed so as to face each other may be disposed in the actuator housing 20. That is, the lens barrel 21 may be moved in the optical axis direction by electromagnetic force generated between the coil (not shown) and the magnet (not shown) adjacent to each other.

The magnet (not shown) may generate a predetermined magnetic field, generate driving force by electromagnetic influence between the magnet (not shown) and the coil (not shown) when power is applied to the coil (not shown), and move the lens barrel 21 in the optical axis direction by the driving force.

The actuator housing 20, which is to support the lens barrel 21, may accommodate the lens barrel 21 and the actuator (not shown) therein.

Therefore, the actuator housing 20 may have an internal space formed therein so as to accommodate the lens barrel 21 and the actuator (not shown) therein.

Meanwhile, the actuator housing 20 may have the cushion pad 30 assembled to a lower portion thereof.

The sensor housing 50 may have an infrared filter 40 attached thereto.

When external light passing through the lens passes through the infrared filter 40, an infrared ray in the light may be cut off. Therefore, introduction of the infrared ray into an image sensor 61 may be prevented.

The sensor housing 50 may have a step part 51 formed on an upper surface thereof in order to attach the infrared filter 40 thereto. Here, the infrared filter 40 may be attached to the step part 51 through an adhesive.

Meanwhile, the sensor housing 50 may be disposed below the actuator housing 20.

Therefore, the actuator housing 20 and the sensor housing 50 may have the cushion pad 30 disposed therebetween, and horizontality of the actuator housing 20 to the sensor housing 50 may be adjusted by the cushion pad 30.

A detailed description thereof will be provided below with reference to FIGS. 3 through 10.

The sensor housing 50 may have the board 60 fixedly disposed thereunder, wherein the board 60 has the image sensor 61 mounted thereon. Here, the sensor housing 50 may be coupled to the board 60 to accommodate the image sensor 61 therein.

The image sensor 61, which collects light incident through the lens barrel 21 to generate an image signal, may be a complementary metal oxide semiconductor (CMOS) sensor or a charge coupled device (CCD) sensor.

An image of a subject may be collected by the image sensor 61 and be stored as data in a memory in a device, and the stored data may be displayed as the image by a display medium in the device.

The image sensor 61 may be mounted on the board 60 and may be electrically connected to the board 60 by a bonding wire.

The case 10 may enclose outer surfaces of the actuator housing 20, the cushion pad 30, and the sensor housing 50 and may serve to shield an electromagnetic wave generated at the time of driving the camera module.

That is, the camera module may generate the electromagnetic wave at the time of being driven. In the case in which the electromagnetic wave as described above is emitted to the outside, it may have an effect on other electronic components to cause communications interference or a malfunction.

In an exemplary embodiment of the present disclosure, the case 10 may be formed of a metal and be connected to a ground pad (not shown) provided on the board 60 to shield the electromagnetic wave.

In addition, when the case 10 is formed of a plastic injection-molded product, an inner surface of the case 10 may be applied with a conductive paint (not shown) to shield the electromagnetic wave.

An example of the conductive paint (not shown) may be a conductive epoxy, but it not limited thereto. That is, various materials having conductivity may be used as the conductive paint. In addition, a conductive film or a conductive tape may also be attached onto the inner surface of the case 10.

The case 10 may be provided with protrusion parts 11 pressing an outer surface of the actuator housing 20.

For example, the protrusion parts 11 may be depressed from an outer surface of the case 10 and may protrude from the inner surface of the case 10.

Since the protrusion parts 11 protruding from the inner surface of the case 10 may press the outer surface of the actuator housing 20, the case 10 and the actuator housing 20 may be easily coupled to each other.

Meanwhile, the case 10 may have an incident hole formed in an upper surface thereof so that external light may be incident through the lens, wherein the external light incident through the incident hole may be received in the image sensor 61 through the lens.

The support wire 70 may have one end fixed to the actuator housing 20 and the other end fixed to the board 60. In addition, the support wire 70 may be electrically connected to the actuator housing 20 and the board 60.

A position of the actuator housing 20 may be fixed by the support wires 70.

A description thereof will be provided below with reference to FIGS. 3 through 10.

FIG. 3 is a partial assembled perspective view of the camera module according to an exemplary embodiment of the present disclosure.

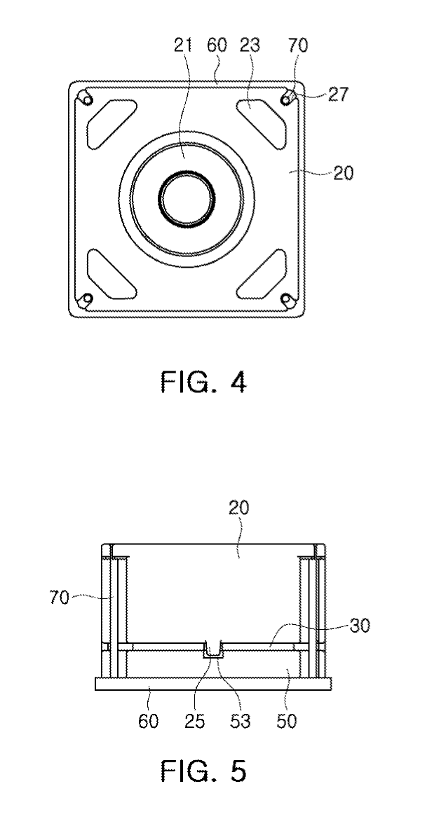

In addition, FIG. 4 is a plan view showing a form before a case is coupled to the camera module according to an exemplary embodiment of the present disclosure; and FIG. 5 is a schematic cross-sectional view showing the form before the case is coupled to the camera module according to an exemplary embodiment of the present disclosure.

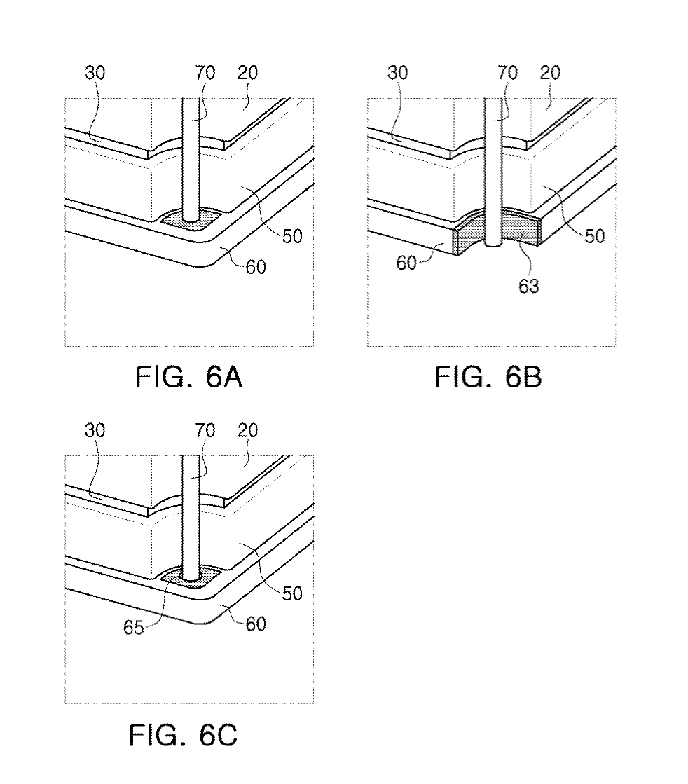

Further, FIGS. 6A through 6C are partially assembled perspective views showing examples of fixing a support wire in the camera module according to an exemplary embodiment of the present disclosure.

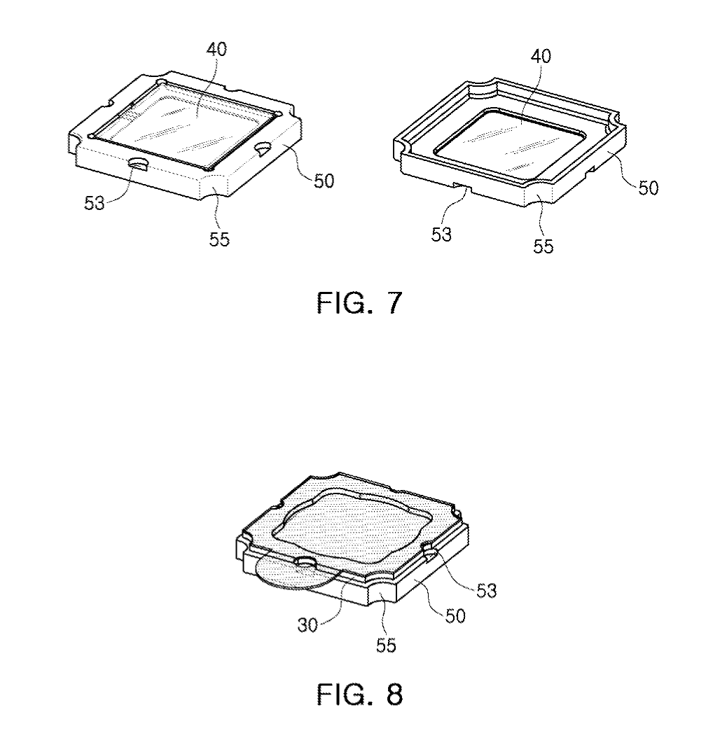

Further, FIG. 7 is a perspective view of a sensor housing of the camera module according to an exemplary embodiment of the present disclosure.

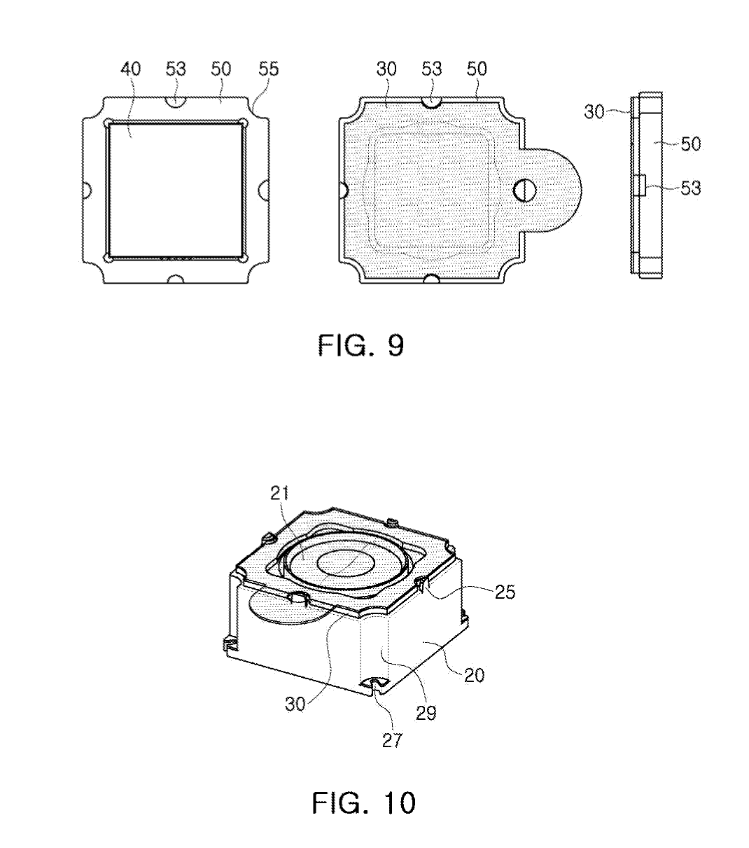

Further, FIG. 8 is an assembled perspective view of the sensor housing and a cushion pad of the camera module according to an exemplary embodiment of the present disclosure; and FIG. 9 is a plan view and a side view of the sensor housing and the cushion pad of the camera module according to an exemplary embodiment of the present disclosure.

Further, FIG. 10 is a bottom perspective view showing a form in which an actuator housing and the cushion pad of the camera module according to an exemplary embodiment of the present disclosure are coupled to each other.

An exemplary embodiment of the present disclosure for easily securing perpendicularity of the optical axis of the lens with respect to an image forming surface of the image sensor 61 will be described with reference to FIGS. 3 through 10.

In the camera module according to an exemplary embodiment of the present disclosure, the actuator housing 20 including the lens barrel 21 and the actuator (not shown) and the sensor housing 50 coupled to the board 61 may be provided as separate components.

The actuator housing 20 and the sensor housing 50 may be coupled to each other with the cushion pad 30 interposed therebetween.

Therefore, an upper portion of the cushion pad 30 may contact a lower portion of the actuator housing 20, and a lower portion thereof may contact an upper portion of the sensor housing 50.

Referring to FIG. 8, the cushion pad 30 may be attached to an upper edge of the sensor housing 50 (or a lower edge of the actuator housing 20 (See FIG. 10)).

The cushion pad 30 maybe attached to the sensor housing 50 together with a protective tape protecting the infrared filter 40 seated on the step part 51 of the sensor housing 50.

The actuator housing 20 may have fixing protrusions 25 protruding from a lower portion thereof, and the sensor housing 50 may have fixing grooves 53 formed in an upper portion thereof so as to correspond to the fixing protrusions 25.

Therefore, the fixing protrusions 25 of the actuator housing 20 may be inserted and coupled into the fixing grooves 53 of the sensor housing 50 with the cushion pad 30 interposed therebetween.

In addition, the cushion pad 30 may have guide grooves 33 formed therein so as to correspond to the fixing grooves 53.

Therefore, when the fixing protrusions 25 are inserted into the fixing groove 53, a position of the cushion pad 30 may be easily aligned by the guide grooves 33.

The cushion pad 30 may have elasticity. For example, the cushion pad 30 may be any one of an elastic plate, a wave spring, and a silicon having the elasticity.

Since the cushion pad 30 has the elasticity, in the case in which at least one side of the actuator housing 20 is pressed toward the sensor housing 50, the cushion pad 30 may be pressed. Therefore, the horizontality of the actuator housing 20 to the sensor housing 50 may be adjusted.

When the actuator housing 20 and the sensor housing 50 are coupled to each other, the actuator housing 20 may be coupled to the sensor housing 50 in a state in which it is inclined with respect to the sensor housing 50 due to an assembling tolerance between the actuator housing 20 and the sensor housing 50.

This may cause the optical axis of the lens not to be aligned perpendicularly to the image forming surface of the image sensor 61. In the case in which the optical axis of the lens is not aligned perpendicularly to the image forming surface of the image sensor 61, a phenomenon such as image quality deterioration, image degradation, or the like, may occur.

Since the optical axis of the lens may not be aligned perpendicularly to the image forming surface of the image sensor 61 due to tolerances of components themselves even though the actuator housing 20 an the sensor housing 50 are coupled in parallel with each other, it may be necessary to align the lens.

Therefore, in the camera module according to an exemplary embodiment of the present disclosure, the cushion pad 30 having the elasticity is disposed between the actuator housing 20 and the sensor housing 50, and at least one side of the actuator housing 20 is pressed toward the sensor housing 50 to press the cushion pad 30, whereby the optical axis of the lens may be aligned perpendicularly to the image forming surface of the image sensor 61.

In other words, in the camera module according to an exemplary embodiment of the present disclosure, at least one side of the actuator housing 20 is pressed to adjust the horizontality of the actuator housing 20 to the sensor housing 50, whereby the optical axis of the lens may be aligned perpendicularly to the image forming surface of the image sensor 61.

Here, the actuator housing 20 may have pressing grooves 23 formed in an upper surface thereof in order to make it easy to press at least one side of the actuator housing 20.

Therefore, jigs are inserted into the pressing grooves 23, and the actuator housing 20 is pressed through the jigs, whereby the horizontality of the actuator housing 20 to the sensor housing 50 may be adjusted.

In addition, since the lens may be aligned by simply pressing the actuator housing 20 through the jigs, a manufacturing process may be simplified, and an additional manufacturing apparatus does not need to be prepared, such that a manufacturing cost may be decreased.

Further, since the cushion pad 30 disposed between the actuator housing 20 and the sensor housing 50 has the elasticity, it may seal a contact surface between the actuator housing 20 and the sensor housing 50, thereby preventing foreign objects from being introduced into the camera module.

Meanwhile, in the camera module according to an exemplary embodiment of the present disclosure, the actuator housing 20 may be moved in a direction (that is, horizontal direction) perpendicular to the optical axis direction to align the optical axis between the lens and the image sensor 61.

That is, in the camera module according to an exemplary embodiment of the present disclosure, the optical axis may be aligned in the direction perpendicular to the optical axis direction as well as in the optical axis direction.

To this end, the fixing groove 53 may have a size larger than that of the fixing protrusion 25.

Therefore, in the case in which the actuator housing 20 is moved in the direction (that is, horizontal direction) perpendicular to the optical axis direction to align the optical axis, the fixing protrusions 25 may be moved within the fixing grooves 53. After the alignment of the optical axis is completed, a position of the actuator housing 20 may be fixed by the support wires 70.

Since the actuator housing 20 needs to be moved in the direction (that is, horizontal direction) perpendicular to the optical axis direction in a state in which the fixing protrusions 25 are inserted into the fixing grooves 53, the fixing grooves 53 may have a size larger than that of the fixing protrusions 25.

Further, in the case in which the actuator housing 20 is moved in the direction (that is, horizontal direction) perpendicular to the optical axis direction to align the optical axis, the fixing grooves 53 may be formed at a size for limiting an aligning range.

After the horizontality of the actuator housing 20 is adjusted, the position of the actuator housing 20 needs to be fixed.

In the camera module according to an exemplary embodiment of the present disclosure, the position of the actuator housing 20 may be fixed by a plurality of support wires 70.

Each of the plurality of support wires 70 may have one end fixed to the actuator housing 20 and the other end fixed to the board 60.

The actuator housing 20 may have notch grooves 27 formed therein in order to fix one ends of the support wires 70, and one ends of the support wires 70 may be soldered to the actuator housing 20.

Referring to FIGS. 6A through 6C, the other ends of the support wires 70 may be soldered to the board 60, and the board 60 may have fixing pads (See FIG. 6A), chamfering parts 63 (See FIG. 6B), or insertion grooves 65 (See FIG. 6C) formed therein in order to fix the other ends of the support wires 70.

As described above, one ends and the other ends of the support wires 70 are soldered to the actuator housing 20 and the board 60, respectively, whereby the position of the actuator housing 20 may be fixed after the horizontality of the actuator housing 20 is adjusted.

In addition, in the camera module according to an exemplary embodiment of the present disclosure, the plurality of support wires 70 are soldered to the actuator housing 20 and the board 60, respectively, in order to fix the position of the actuator housing 20, whereby position distortion due to a change in thermal characteristics that may appear in the case of using an adhesive hardening scheme may be prevented.

Further, since bonding strength may be improved by fixing the plurality of support wires 70 to the actuator housing 20 through the soldering, reliability of the camera module against external impact may be secured, and a change due to external environment factors (temperature, humidity, and external force) may be prevented.

In addition, when a defect due to foreign objects and a performance defect occur, the plurality of support wires 70 are removed to easily separate the respective components of the camera module, whereby the camera module may be easily repaired.

Meanwhile, the actuator housing 20, the cushion pad 30, and the sensor housing 50 may have avoidance grooves 29, 33, 55 formed therein, respectively, so that the support wires 70 pass therethrough.

As set forth above, in the camera module according to exemplary embodiments of the present disclosure, the perpendicularity of the optical axis of the lens to the image forming surface of the image sensor may be easily secured.

Distortion of the perpendicularity of the optical axis of the lens to the image forming surface of the image sensor in the adhesive hardening process may be prevented.

Further, the support wires are fixed to the actuator housing through the soldering, whereby the bonding strength may be improved.

Further, the camera module may be easily repaired by removing the support wires when the defect due to the foreign objects and the performance defect occur.

Further, the cushion pad is disposed between the actuator housing and the sensor housing, whereby the defect due to the foreign objects may be prevented.

While exemplary embodiments have been shown and described above, it will be apparent to those skilled in the art that modifications and variations could be made without departing from the spirit and scope of the present disclosure as defined by the appended claims.

What is claimed is:

1. A camera module comprising:
an actuator housing accommodating a lens barrel therein;
a sensor housing disposed below the actuator housing;
a cushion pad disposed between the actuator housing and the sensor housing;
a board coupled to a lower portion of the sensor housing and having an image sensor mounted thereon; and
a plurality of support wires, one ends thereof being fixed to the actuator housing and the other end fixed to the board.

2. The camera module of claim 1, wherein the cushion pad is attached to an upper edge of the sensor housing.

3. The camera module of claim 1, wherein an upper portion of the cushion pad contacts a lower portion of the actuator housing, and a lower portion thereof contacts an upper portion of the sensor housing.

4. The camera module of claim 1, wherein the cushion pad is any one of an elastic plate, a wave spring, and a silicon having elasticity.

5. The camera module of claim 1, wherein the actuator housing, the cushion pad, and the sensor housing have avoidance grooves formed therein, respectively, so that the support wires pass therethrough.

6. The camera module of claim 1, wherein the actuator housing has fixing protrusions protruding from a lower portion thereof, and the sensor housing has fixing grooves formed in an upper portion thereof so as to correspond to the fixing protrusions.

7. The camera module of claim 6, wherein the fixing groove has a size larger than that of the fixing protrusion.

8. The camera module of claim 6, wherein the cushion pad has guide grooves formed therein so as to correspond to the fixing grooves.

9. The camera module of claim 1, wherein the actuator housing has pressing grooves formed in an upper surface thereof.

10. The camera module of claim 1, wherein the sensor housing has a step part formed on an upper surface thereof, the step part having an infrared filter seated thereon.

11. The camera module of claim 1, wherein one end and the other end of the support wire are soldered to the actuator housing and the board, respectively.

12. A camera module comprising:
an actuator housing accommodating a lens barrel therein;
a sensor housing disposed below the actuator housing and having an infrared filter attached to an upper surface thereof;
a cushion pad disposed between the actuator housing and the sensor housing and pressing at least one side of the actuator housing to adjust horizontality of the actuator housing to the sensor housing;
a board coupled to a lower portion of the sensor housing and having an image sensor mounted thereon; and
a plurality of support wires, one ends thereof being fixed to the actuator housing and the other end fixed to the board.

13. The camera module of claim 12, wherein the actuator housing has fixing protrusions protruding from a lower portion thereof, and the sensor housing has fixing grooves formed in an upper portion thereof so as to correspond to the fixing protrusions.

14. The camera module of claim 13, wherein the fixing groove has a size larger than that of the fixing protrusion.

15. The camera module of claim 12, wherein a position of the actuator housing is fixed by the support wires.

16. The camera module of claim 12, wherein one end and the other end of the support wire are soldered to the actuator housing and the board, respectively.
